(19) United States
(12) Patent Application Publication
(10) Pub. No.: US 2004/0059903 A1
(43) Pub. Date: Mar. 25, 2004

(54) Control system and method for rack mounted computer units

(76) Inventors: John V. Smith, Poway, CA (US); Victor P. Hester, El Cajon, CA (US)

Correspondence Address: DUCKOR SPRADLING METZGER, 401 WEST A STREET, SUITE 2400, SAN DIEGO, CA, 92101-7915, US

(21) Appl. No.: 10/656,024

(22) Filed: Sep. 5, 2003

Related U.S. Application Data
(60) Provisional application No. 60/413,922, filed on Sep. 25, 2002.

(51) Int. Cl. G06F 1/30; G06F 1/28; G06F 1/26; G21C 17/00; G06F 15/00; G06F 11/30; G06F 15/177; G06F 9/24; G06F 9/00

(52) U.S. Cl. 713/1; 713/300; 702/186

(57) ABSTRACT

The method includes receiving a command signal by a reset control module from another source such as a remote computer through a network. The command signal includes instructions to manipulate or control a computer unit such as a computer, computer component or computer system. An execution signal is transmitted for manipulation or control of the computer, computer component or computer system. The controlling or manipulation includes resetting, powering on or powering off the computer, computer component or computer system.

### RELATED APPLICATION

This application claims priority to U.S. provisional patent application Serial No. 60/413,922, titled REMOTE RESET SYSTEM AND METHOD FOR COMPUTER COMPONENTS AND SYSTEMS, filed Sep. 25, 2002, which is hereby incorporated by reference in its entirety. Additionally, priority is claimed to U.S. non-provisional patent applications Ser. No. 10/449,799, filed May 29, 2003, titled “Rack Mountable Computer Component and Method of Making Same”; Ser. No. 10/448,691, filed May 29, 2003, titled “Rack Mountable Computer Component Cooling Method and Device”; Ser. No. 10/449,608, filed May 29, 2003, titled “Rack Mountable Computer Component For Cooling Arrangement and Method; and Ser. No. 10/448,508, filed May 29, 2003, titled “Rack Mountable Computer Component Power Distribution Unit and Method”.

This application is related to U.S. patent application Ser. No. 10/160,526, titled “Method and Apparatus for Rack Mounting Computer Components,” filed May 31, 2002, U.S. Provisional Application Serial No. 60/384,996, titled “Rack Mountable Computer Component and Method of Making Same,” filed May 31, 2002; U.S. Provisional Application Serial No. 60/384,987, titled “Rack Mountable Computer Component Cooling Method and Device,” filed May 31, 2002; U.S. Provisional Application Serial No. 60/384,986, titled “Rack Mountable Computer Component Fan Cooling Arrangement and Method,” and U.S. Provisional Application Serial No. 60/385,005, titled “Rack Mountable Computer Component Power Distribution Unit and Method,” filed May 31, 2002, which are each hereby incorporated by reference in their entirety.

### BACKGROUND OF THE INVENTION

1. Field of the Invention

The present invention relates in general to computer components. It more particularly relates to a system and method for remote monitoring and resetting of computer components or systems.

2. Related Art

There have been a variety of different types and kinds of methods and systems for mounting computer components. For example, reference may be made to the following United States patents:

| PATENT NO. | INVENTOR | ISSUE DATE |
|---|---|---|
| 4,258,967 | Boudreau | Mar. 31, 1081 |
| 4,879,634 | Storrow et al. | Nov. 07, 1989 |
| 4,977,532 | Borkowicz et al. | Dec. 11, 1990 |
| 5,010,444 | Storrow et al. | Apr. 23, 1991 |
| 5,216,579 | Basara et al. | Jun. 01, 1993 |
| 5,460,441 | Hastings et al. | Oct. 24, 1995 |
| 5,571,256 | Good et al. | Nov. 05, 1996 |
| 5,684,671 | Hobbs et al. | Nov. 04, 1997 |
| 5,877,938 | Hobbs et al. | Mar. 02, 1999 |
| 5,896,273 | Varghese et al. | Apr. 30, 1999 |
| 6,025,989 | Ayd et al. | Feb. 15, 2000 |
| 6,058,025 | Ecker et al. | May 02, 2000 |
| 6,075,698 | Hogan et al. | Jun. 13, 2000 |
| 6,220,456 B1 | Jensen et al. | Apr. 24, 2001 |
| 6,305,556 B1 | Mayer | Oct. 23, 2001 |
| 6,315,249 B1 | Jensen et al. | Nov. 13, 2001 |
| 6,325,636 B1 | Hipp et al. | Dec. 04, 2001 |
| Re. 35,915 | Hastings et al. | Oct. 06, 1998 |
| Des. 407,358 | Belanger et al. | Mar. 30, 1999 |

Computer systems such as networks, rack mounted computer clusters, or mainframes may generally be provided with a control that is physically mounted on each unit for resetting the unit. In this regard, the performance of one or more units may be monitored remotely to detect possible malfunctions. Such malfunctions are typically resolved simply by shutting down and restarting, or resetting, the unit.

In a typical environment, many units may be monitored remotely while the units are located in another room, another building or even another city. When a malfunction is detected at the remote location, a user must physically travel to the location of the unit, determine which of typically many physical units corresponds to the detected malfunction, and physically shut down and restart the unit. The user may then return to the remote monitoring location. If the malfunction re-occurs, the user must repeat the process, including the travelling to the location of the unit.

### BRIEF DESCRIPTION OF THE DRAWINGS

The following is a brief description of the drawings:

FIG. 1 is a pictorial view of a rack-mounted computer system showing the front, left side and top thereof, which may use an embodiment of the present invention;

FIG. 2 is a pictorial view of a housing of the system of FIG. 1, illustrating the process of installation of computer blades;

FIG. 3 is an enlarged scale top view of one embodiment of a blade of the rack-mounted system of FIG. 1;

FIG. 4 is a left side elevational view of the blade of FIG. 3;

FIG. 5 is a block diagram of the system of FIG. 1, illustrating the control arrangement according to one embodiment of the present invention;

FIG. 6 is a block diagram of a reset control module for the control arrangement of FIG. 5;

FIG. 7 is a schematic diagram of an optical isolator arrangement of the reset control module of FIG. 6; and

FIG. 8 is a schematic diagram of an alternative embodiment of an optical isolator arrangement of the reset control module of FIG. 6.

### DESCRIPTION OF CERTAIN EMBODIMENTS OF THE INVENTION

The following detailed description is organized according to the following outline:

A) General Overview

B) General System Description

C) Reset Control System

D) Reset Control Hardware

E) Reset Control Software Method

According to at least one of the disclosed embodiments of the present invention, there is provided a system and a method for controlling a computer unit such as a computer, a computer component or a computer system.

The method includes receiving a command signal by a reset control module from another source such as a remote computer through a network. The command signal includes instructions to manipulate or control a computer unit such as a computer, computer component or computer system. An execution signal is transmitted for manipulation or control of the computer, computer component or computer system. The controlling or manipulation includes resetting, powering on or powering off the computer, computer component or computer system.

The method may also include receiving a data signal from at least one of a sensor and the computer, computer component or computer system. The data signal may include information relating to operation of the computer unit such as a computer, computer component or computer system. A notification signal may be transmitted by the reset control module for receipt by the remote computer, the notification signal being transmitted through the computer network and including the information relating to operation of the computer, computer component or computer system.

In a preferred embodiment, the data signal includes an operating temperature of the computer, computer component or computer system. The information may include an alarm indicating the operating temperature exceeding a high temperature threshold or dropping below a low temperature threshold.

The remote computer may be a personal computer or a workstation. In one embodiment, the computer network is a public network, such as the Internet. In another embodiment, the computer network is an intranet or a local area network.

A disclosed embodiment of the system includes a reset control module, one or more computer units such, for example, as computers, computer components or computer systems adapted to communicate with the reset control module. The reset control module is adapted to transmit information relating to operation of the computer units to a computer or other terminal such as a remote personal computer and to receive instructions therefrom for control or manipulation of the computer unit. The remote computer is adapted to communicate with the reset control module through a computer network.

B. General System Description

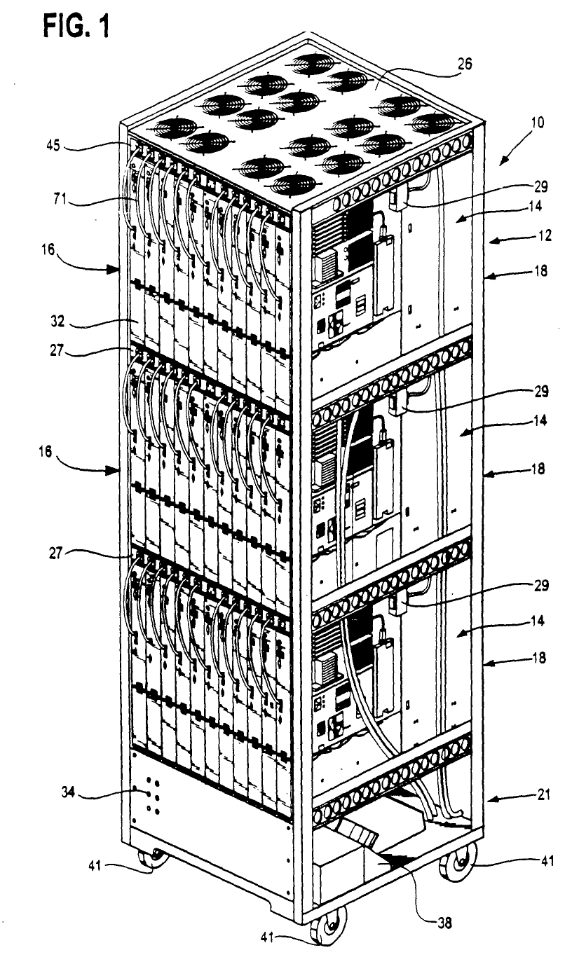

Referring now to the drawings, and more particularly FIGS. 1-4, there is illustrated one embodiment of a vertical computer unit rack mounted system 10, which may be used with the diagnostic assembly of an embodiment of the invention as hereinafter described in greater detail. It should be understood that different rack mounted systems and other types and kinds of systems may also be employed, such, for example, as horizontal rack mounted computer units. The rack mounted system 10 includes a rack housing 12 configured generally as a rectangular box having a plurality of vertically spaced-apart bays 14. The embodiment illustrated in the drawings includes three vertically spaced-apart bays 14.

Each bay 14 is divided into a front bay portion 16 and a rear bay portion 18 by an intermediate transversely-extending horizontal divider 19. The bays 14 are formed in the rack housing 12 in a vertically spaced-apart manner one above the other. In a bottom portion of the rack housing 12, a control bay 21 is provided to house various control components for controlling various computer units of the system 10 according to the disclosed embodiments of the present invention, as hereinafter described in greater detail.

The rack housing 12 further includes a fan/LAN tray slot 23 above each bay 14. Each fan/LAN tray slot is configured to accommodate a fan/LAN tray such as tray 27.

The system illustrated in the drawings provides a control bay 21 used for controlling the system 10 as hereinafter described in greater detail. The control bay 21 has a bottom opening 25 for facilitating air flow to receive vertically moving air flow from a vent opening 26 in a floor 28 and vertically through the system 10 as assisted by the fan/LAN trays. At the top of the rack housing 12, an apertured top panel 26 is provided to permit venting of the vertically moving air flow from the system 10.

At the top portion of each bay 14, in the intermediate region between the front bay portion 16 and the rear bay portion 18, a power distribution unit (PDU) 29 is provided to supply electricity to various components mounted in the rack mounted system. Each bay is adapted to accommodate a plurality of computer components in the form of open structure computer blades, such as blade 32, in each of the front bay portions 16 and the rear bay portions 18. In the embodiment illustrated in the figures, eleven blades may be accommodated in each of the front bay and rear bay portions. Thus, in the illustrated embodiment, the system 10 accommodates 66 computer components in a densely compact, closely spaced configuration.

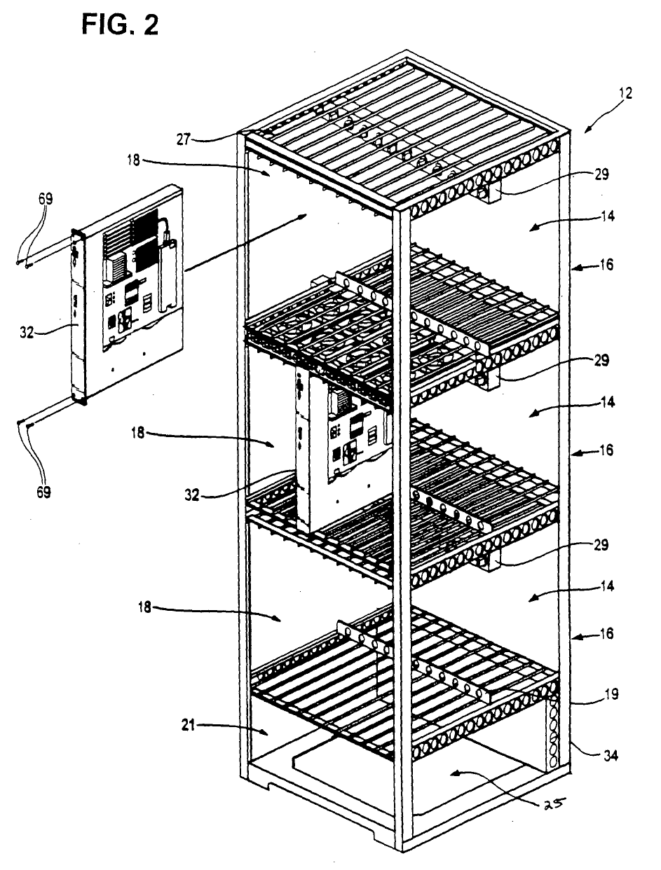

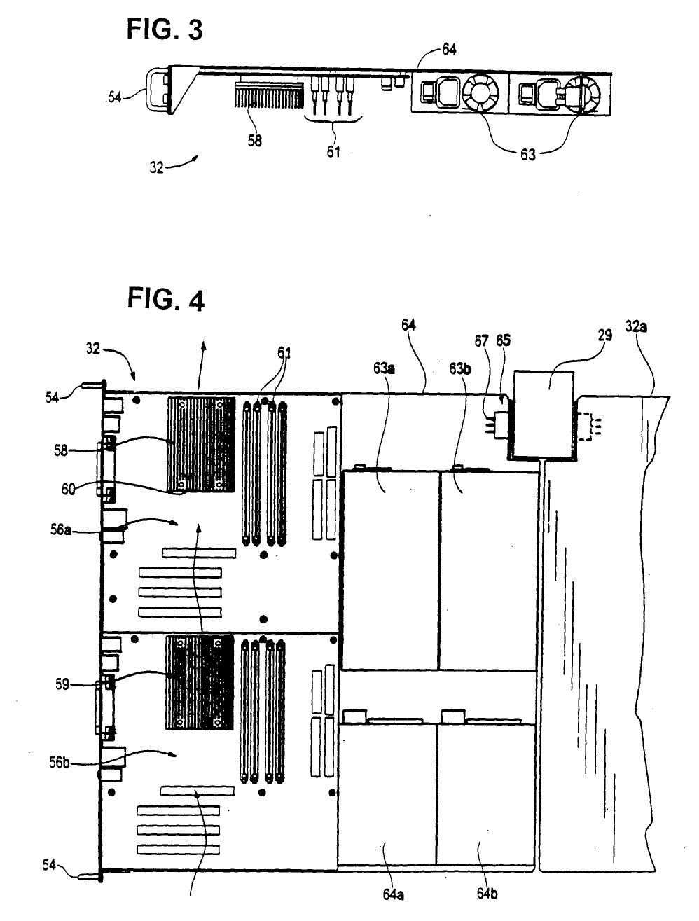

Referring now to FIGS. 2-4, the blades 32 and their installation into the rack housing 12 will now be described in greater detail. Each blade is provided with a pair of handles 54 which allow a user to easily manipulate the blade 32 to be grasped by the user to slide the blade into or out of its bay. Each blade 32 may include one or more mother boards 56. In the system illustrated in FIGS. 3 and 4, each blade 32 includes two mother boards 56a, 56b. Those skilled in the art will appreciate that the number of mother boards included in each blade 32 may be varied according to design. The mother board may include heat sinks such as heat sinks 58 and 59 for facilitating the cooling of the mother boards. Examples of the heat sinks are disclosed in greater detail in U.S. provisional application Serial No. 60/384,487, filed May 31, 2002. Further, each mother board is provided with random access memory (RAM) 61. The amount of RAM 61 provided for each mother board may be varied as needed. A pair of power supply 63a, 63b may be provided on the blade 32 for supplying power to their corresponding mother boards 56a, 56b. Similarly, a pair of hard disks 64a, 64b may also be provided on the blade 32.

All of the components are mounted on one side of a rigid plate or support 64, which is adapted to be supported vertically within its bay. Each blade 32 includes a cut-out corner portion or section 65 in its upper back portion. The cut-out portion 65 is sized to receive and accommodate the PDU 29 therebetween such that two opposing blades 32 and 32a accommodate the PDU 29 almost completely. Thus, a substantially zero footprint is achieved for the PDU 29. Each blade 32 is provided with an AC power inlet such as an inlet 67 at or near the cut-out portion 65. Thus, when the blade 32 is installed into the rack housing 12, the AC power inlet 67 engages electrically a corresponding AC connector such as a connector 76 of the PDU 29.

As most clearly illustrated in FIG. 2, the installation of the blade 32 may be achieved in a fast and efficient manner. The blade 32 is simply slid into either the front bay portion 16 or the rear bay portion 18 of a bay 14 of the rack housing 12. Each blade 32 is slid back until its AC power inlet 67 engages a corresponding AC connector 76 on the PDU 29. The intermediate dividers 19 serve as a back stop for the blades 32. Each blade 32 is secured in its slot by four blade screws 69, which attach the blade 32 to the rack housing 12.

Once the blade 32 has been mounted onto the rack housing 12, a short blade/LAN connector cable such as a cable 71 provides electrical networking connection between the blade 32 and a network such as a local area network, wide area network or a public network such as the internet. In this regard, the mother boards are each mounted at the front of each blade, and thus access thereto is readily available at front outlets.

Each rack system 10 may include one or more master blades located, for example, in the front lowest bay, with the remainder of the blades being slave blades being at least partially controlled by or through the master blades.

C. Reset Control System

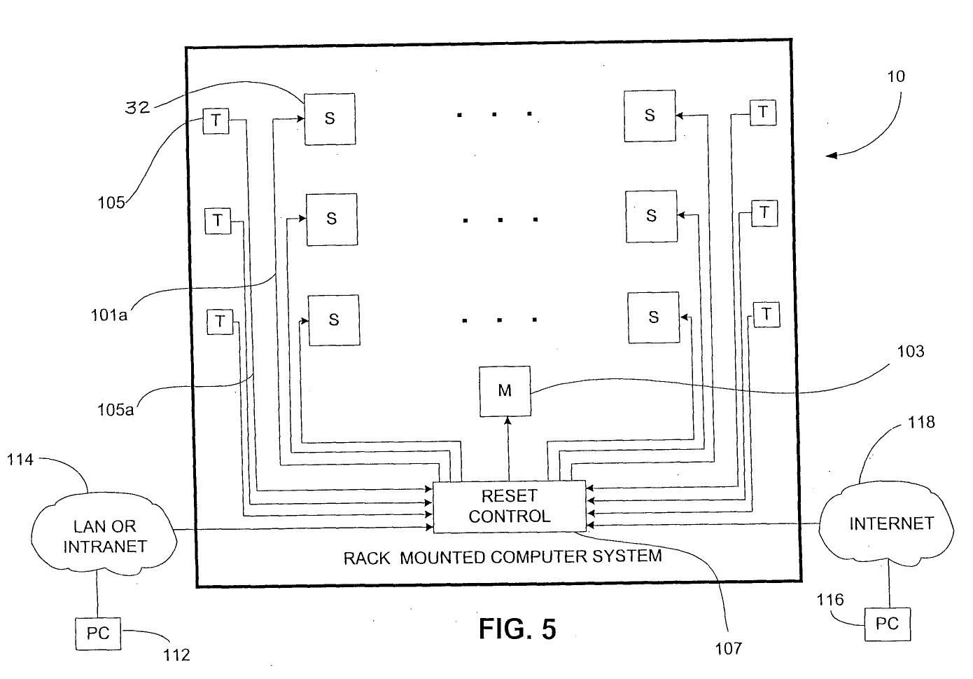

A system for controlling computer units such as the computer components or systems described above with reference to FIGS. 1-4 will now be described in greater detail with reference to FIGS. 5-8. The disclosed embodiments of the system and methods enable a user to control one or more computer units, and the control can be executed remotely, if desired, without physically travelling to the location of the computers, computer components or computer systems to be controlled. It is to be understood that the control can be executed locally as well, and can be accomplished according to certain embodiments of the invention substantially without human intervention.

FIG. 5 illustrates one embodiment of a system for controlling by monitoring and/or resetting of computer units mounted on, for example, the rack assembly described above with reference to FIGS. 1-4 either remotely or locally. In this embodiment, the computer system 10 is constructed and arranged with the blades, such as the blade 32, serving as slaves. The blades are designated in FIG. 5 with the letter “S” such as the blade 32. Also, one of the blades serves as a master blade 103. Of course, it will be understood by those skilled in the art that the computer system 10 may be provided with more than one master blade 103, and any number of slave blades. In one embodiment, no master blades are provided, and the existing blades (no longer slave blades) are controlled directly, rather than through the master blade.

The system 10 further includes thermal couples, such as thermal couple 105. The thermal couples may be strategically located, for example, within each bay of a rack system. In further embodiments, a thermal couple is provided near or within each component such as a blade. Accordingly, the number of thermal couples included in the system 10 may be varied as needed.

The thermal couple 105 is adapted to detect a temperature of, for example, an environment around or within a component. In this regard, the thermal couples may detect the operating temperature of the computer, computer component or computer system and transmit the value to an external recipient. Such thermal couples are well known to those skilled in the art.

The blades, such as slave blade 32, and the thermal couples, such as thermal couple 105, are adapted to communicate with a reset control module 107 forming a part of the control bay 21 through cables, such as cables 101a and 105a. In a preferred embodiment, each cable linking the reset control module 107 to a blade or a thermal couple is a two-wire cable.

The reset control module 107 is adapted to receive data from each thermal couple, such as thermal couple 105. Further, the reset control module 107 is adapted to receive and send signals from and to the various blades, including slave blade 32 and master blade 105. In this regard, the reset control module 107 may receive computer unit performance signals including performance data for each blade. For example, the data may include indications of a malfunction and requesting attention.

A user, such as a system administrator may communicate with the reset control module 107 using a remotely located computer 112, such as a personal computer or a workstation. It should be understood that the computer 112 may also be located on the same site as the computer units being monitored. The computer 112 may communicate with the reset control module 107 through a network 114 of computers such as an Intranet or a local area network (LAN). The computer 112 may be located in a different room, building or city from the system 100. The network 114 allows two-way communication between the reset control module 107 and the computer 112. The user may also communicate with the reset control module 107 using a personal computer 116 through a public network 118 such as the Internet.

In operation, the reset control module 107 receives signals from the thermal couples, such as thermal couple 105, through the cables, such as cable 105a. The signals may include data relating to the operating temperature of the computer, computer component or computer system, such as a blade. The data is transmitted to the reset control module 107 from each thermal couple. The reset control module 107 may receive the data at a pre-determined frequency, such as one hertz, thereby providing regular updates to the reset control module 107.

Further, the reset control module 107 may also receive signals from the various computers, computer components or computer systems, such as blades 103, 101. These signals may include further data relating to the operation of the blades, such as operating efficiency, capacity, etc.

The temperature and other operating information may be monitored through the networks 114 or 118 by the user at the computers 112 or 116. If a malfunction is detected at one of the blades, for example, a signal may be transmitted from one of the computers such as the computers 112 and 116 to the reset control module 107 to shut down or reset the particular computer, component or system. For example, a malfunction may be detected as a temperature above a pre-determined threshold at one of the thermal couples. The high temperature may indicate that, for example, a ventilation fan has failed, thereby threatening to destroy or damage one or more components. In this scenario, either one blade or an entire bay of blades may be shut down or reset.

The reset is performed when a signal is sent from one of the remote computers 112 and 116 to the reset control module 107. The signal may contain instructions for the reset control module 107 to shut down the necessary components. The reset control module 107, in turn, may itself shut down or reset the appropriate components. Alternatively, the reset control module 107 may transmit a further signal to the component requesting the component reset itself.

In a further embodiment, the reset control module 107 may be provided with a pre-set threshold for resetting various components. For example, the reset control module 107 may be provided with a maximum temperature detected by the thermal couples. If the thermal couples indicate a temperature above that threshold, the reset control module 107 may initiate the reset process automatically without involving the remote computers 112 and 116. In this regard, the threshold may be modified remotely by the user using the computer 112, 116. A signal may be transmitted from one of the computers 112 and 116 to the reset control module 107 through a network such as the networks 114 and 118 providing a new threshold.

D. Reset Control Hardware

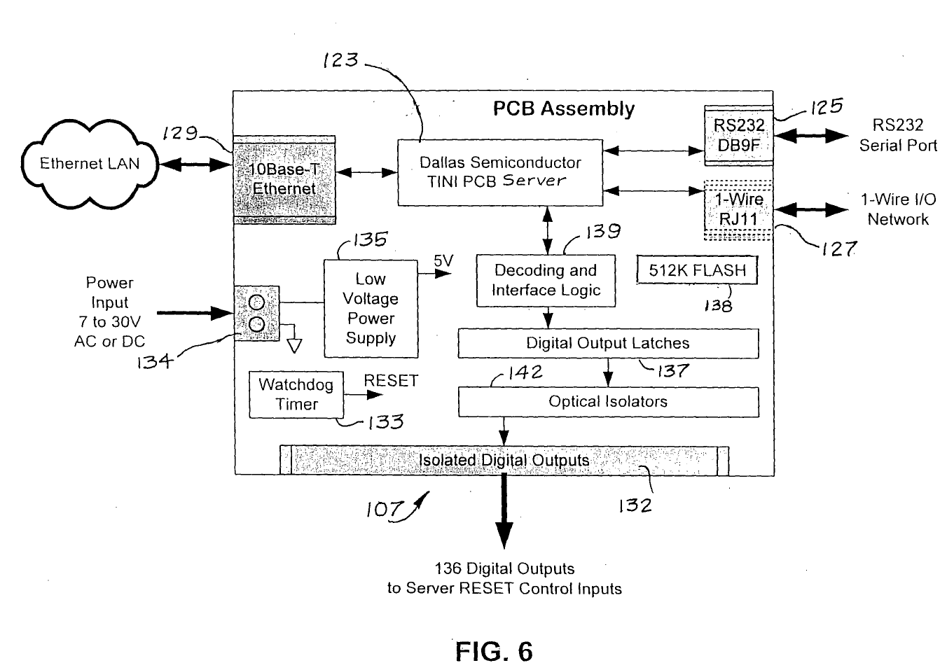

Referring now to FIG. 6, the hardware design of one embodiment for the reset control module 107 is illustrated in the form of a printed circuit board (PCB) assembly. FIG. 6 shows the functional blocks and connector interfaces contained on the PCB assembly for the module 107.

The disclosed embodiment of the module 121 provides control of 136 power and reset outputs and monitoring of temperature input via a mini web server 123. The mini web server 123 may be implemented using the Dallas Semiconductor TINI™ product. The control and monitoring functions may be provided via a Java™ Applet embedded into an html web page. The disclosed embodiment of the module 107 includes an integral TINI™ PCB 123, communications interfaces 125, 127, and 129, and 136 isolated digital outputs indicated at 132.

The power input requirements for the disclosed embodiment of the PCB assembly 121 are 7-to-30V AC or DC at 500 mA maximum. The power input is not isolated from the PCB logic and internal ground. The power input is made via a two-part header 134 that can accept #22 to #16 AWG wire and is supplied to a low voltage power supply 135.

The PCB assembly 121 is contains a watchdog timer 133 that provides supervision of the application software and monitors the logic power supply. The watchdog timer 133 is used to increase the reliability of the system and eliminates the need for a manual restart in the event of an unforeseen malfunction.

The disclosed embodiment of the module 107 connects to local area networks via a 10Base-T Ethernet interface 129 that is terminated by a RJ-45 connector (not shown). The interface 129 is generally terminated at one of the networks hub or switch ports. The Ethernet interface TCP/IP settings can be made via the RS232 port 125 or a network Telnet session. The former is used for PCB assembly's “1^{st} Birthday” configuration or when the network settings are unknown.

The disclosed embodiment of the module 107 includes a Dallas Semiconductor 1-Wire™ network that is terminated by a standard RJ-11 connector 127. The pin out arrangement is compatible with a variety of third party 1-Wire™ I/O devices that range from temperature sensors to complex I/O points.

The disclosed embodiment of the PCB assembly 121 contains a serial RS232 communication port 125 that is terminated by a DB9 female connector (not shown). The RS232 port 125 may interface to a personal computer with a common null modem cable. The RS232 port 125 is used to access the system software for configuration purposes, and is functionality available for future expansion of the product.

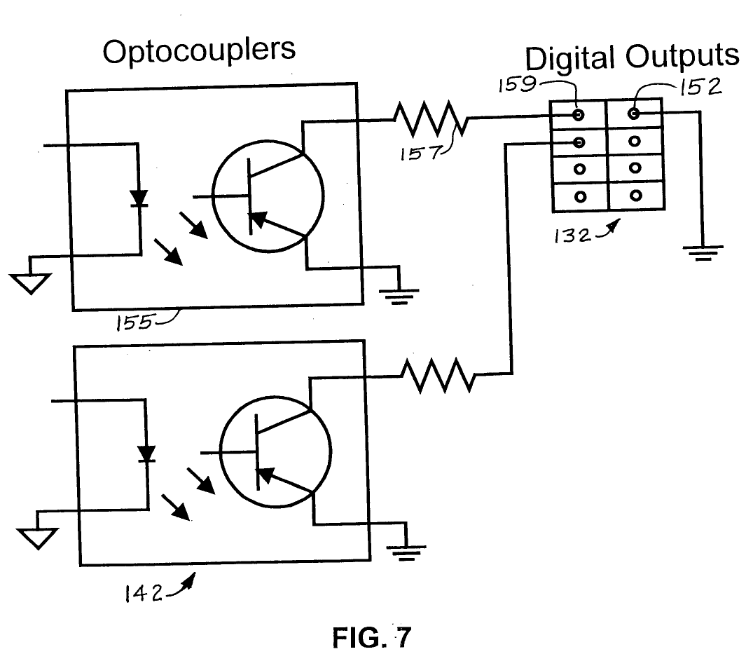

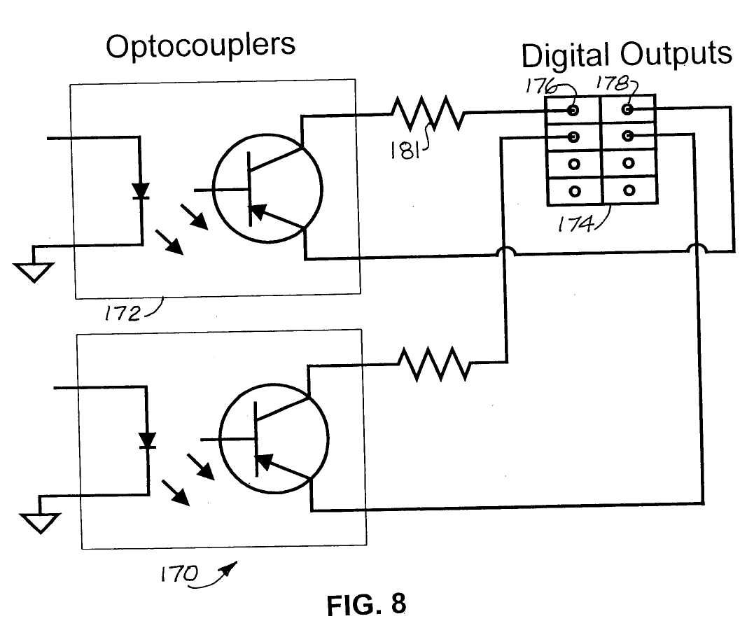

The disclosed PCB assembly 121 contains 136 digital outputs indicated at 132 that can be remotely controlled via a web browser and TCP/IP. The output states are written to latch devices 137 via decoding and interface logic 139 by the application software. Each output channel is optically isolated by means of optical isolators 142 from the PCB assembly 121 ground or common point by at least 1500 VAC continuous. Each channel can be independently controlled via the application software. All of the outputs go to the inactive state when the PCB (TINI CPU) is in a system reset. Each channel provides a current sink output capable of switching up to 50 mA to a return wire at 12 VDC. The digital outputs are terminated to a connector and pin out arrangement (not shown). The digital output common return isolation may be arranged with either a common or independent return path as described below with reference to FIGS. 7 and 8.

FIG. 7 illustrates schematically the optical isolators 142 and how they are coupled to the digital outputs 132. The arrangement shown in FIG. 7 is a common return path topology. The return path for multiple channels can share a common grounded connector pin such as a pin 152. It is presently preferred in the disclosed embodiment that the sharing of the common ground should preferably be limited to six channels or fewer for some applications. The advantage for some applications is that the connector requires less than two pins per output channel.

The optical isolators 142 include optocouplers, such as optocoupler 155, which have their outputs coupled through current limiting resistors such as a resistor 157 for the optocoupler 155, to the digital outputs 132. The outputs 132 include a first series of pins, such as a pin 159, connected to the optocouplers 142, and a second series of pins such as the pin 152. The first and second series of pins are arranged in pairs, such as the pins 159 and 152. Thus, for example, when the optocoupler 155 is activated, ground is then switched to the pin 159 to send the control signal to a given blade. It should be understood that only two optocouplers and four pairs of digital output pins are illustrated for sake of simplicity.

FIG. 8 is another embodiment of an optical isolator arrangement in the form of an independent return path topology. The advantage of this configuration for some applications is that the signal commons on the target systems do not get interconnected.

The optical isolator 170 of FIG. 8 includes a group of optocouplers such as an optocoupler 172 and a group of digital outputs 174 arranged in pairs of pins such as pins 176 and 178. The pin 176 is connected through a current limiting resistor 181 to one output of the optocoupler 172 and its other output is connected directly to the pin 178. Thus, there are no common grounds.

Referring again to FIG. 6, the disclosed embodiment of the PCB assembly 121 may contain footprints for the circuitry necessary to add an additional 512K FLASH memory 138. The additional FLASH memory may be used to store larger application programs.

E. Reset Control Software Method

The software functional operation and design of one embodiment of a printed circuit board (PCB) assembly 121 for use with the reset control module 107 will now be described.

The disclosed embodiment of the PCB assembly 121 provides control of 136 power and reset outputs and monitoring of temperature input via the mini web server 123. The control and monitoring functions may be provided via a Java™ Applet embedded into an html web page. The user connects to the system using a web browser and opens the control and monitor web page that then starts the Applet program. After Applet initialization, a login dialog box may be displayed requiring a username and password. The user must successfully login before the user can access the Applet controls and displays.

Once successfully logged in, the user can select 1 of 68 possible power and reset pairs to be controlled. The user can select to send either a power or reset trigger. The power trigger is selected to be either a “Power On” or a “Power Off” signal. A button is pressed to execute the command and to transmit the signal to the appropriate power or reset output. This signal remains active for a preset, configurable time and automatically clears itself without user intervention. The temperature input reading is periodically updated on the Applet display and displayed in degrees Celsius or Fahrenheit as configured. A configurable description for the temperature input is also displayed beside the temperature value. An alarm flag may be displayed in the event that the temperature value exceeds a “High Alarm” set point or drops below a “Low Alarm” set point. An email message can be configured to be sent when an alarm is active.

The software for the RackSwitch product may be divided into two main software sub components as follows: the I/O board, and the control Applet.

The I/O board software component is designed to operate on the Dallas Semiconductor TINI™ server 123 and may be based on the Dallas Semiconductor TINI™ Operating System. The operating software is provided by Dallas Semiconductor for development on the TINI™ server 123. The I/O Board may include 136 digital outputs and a 1-Wire™ temperature input. The digital outputs are defined as a reset or a power output.

The I/O Board software performs several functions in addition to the functions provided by the Dallas Semiconductor TINI™ Operating System. The I/O Board implements a small HTTP server used to serve the control Applet and associated html file when a user request is received. It updates the power and reset outputs based on user requests and timing specifications, and maintains a system log file. The I/O Board periodically reads the temperature inputs and maintains a temperature value between readings. The I/O Board sends email alarms to a configured email address when the temperature reading exceeds a high set point or drops below a low set point. It maintains and services user TCP/IP network connections, and provides username and password login functions for the control Applet. The I/O Board implements system initialization and configuration, and reads and calculates current date and time based on a real-time clock interface provided with the Dallas Semiconductor TINI™server 123.

The TINI™ Operating System may be the basis for most software operation. In addition to many other features the operating system provides password utilities for managing user accounts, setting the current date and time and configuring network settings. The operating system may be modified for the reset system. During operating system initialization, if the password file is corrupt and/or can not be opened or found, then a default password file is automatically created that contains a default username and password. During operating system initialization, the operating system startup file is automatically created when the file is corrupt and/or can not be opened or found. The default startup file contains the startup line call and the default command line parameters.

Usernames and passwords provide privilege levels: administrative and general. Administrative privilege levels allow a user unlimited access to any aspect of the system as well as any TINI™ Operating System configurations and file system operations. General privilege level permits the user unlimited access to the system features and functions, but limited access to the TINI™ Operating System configurations and functions. The usernames and passwords are maintained in a standard text file with the passwords being encrypted using the TINI™ Operating System password encryption function. Utilities provided in the TINI™ Operating System provide means for adding, deleting and/or modifying system usernames and passwords.

The system log file is a standard text file that lists system events with a date and time stamp. System events include, but are not limited to, system startup, user logins, Java runtime exceptions, records of user actions for “Power On,” “Power Off” and “Reset” and temperature alarms when configured and enabled.

The temperature sensor may be based on the Dallas Semiconductor 1-Wire™ Temperature Sensor, DS18S20. The temperature input may be read periodically and may update the temperature value transmitted to all connected users. The temperature input provides configurable parameters for a description field to be displayed by the Applet, a unit designator for Fahrenheit or Celsius, “Alarm High” set point, “Alarm Low” set point, alarm enable, and an email alarm enable. When the “Alarm High” set point is exceeded, the High alarm flag is set if the alarm is enabled. When the temperature value is less than the “Alarm Low” set point then Low alarm flag is set if the alarm is enabled. If either alarm is active and the email alarm enable is set then the email alarm flag is set.

The outputs are classified as a reset or a power output. Each output can be activated for a configured amount of time, for example, from one to thirty seconds. Times configured less than 1 second are automatically set to 1 second and configured times greater than 30 seconds are automatically set to 30 seconds so that the range of time values is always valid. The time configuration is a global configuration for all power and reset outputs and may not be individually configurable.

The power and reset are paired together and the user can perform actions on a single power and reset pair or all power and reset pairs.

Email alarms for the temperature input will be automatically sent for active alarms. Configurable email alarm parameters are: Delay Time (seconds), Repeat Count, Mail To Address. The Delay Time is the amount of time to delay after an alarm has gone active before sending the email alarm. The Repeat Count is the number of times the email alarm is sent while the alarm is active. The Mail To address is the email address of the recipient for the email alarm. When an alarm is activated the email alarm function waits the Delay Time and then sends the email to the configured recipient. If the Repeat Count is greater than or equal to 1 then another email alarm will be sent after the Delay Time expires again. This will repeat for the Repeat Count times. If the email alarm would become inactive anytime during this process then the alarm active state is cleared and the email alarm would cease and reinitialize. If the email alarm would become active again the process would start over again.

A mail host is configured in the TINI™ Operating System IP Configuration using the provided configuration command.

The configurable parameters are configured through a standard text configuration file. Parameters are typically comma delimited. The configuration parameters are read once during initialization and startup. The configuration file is modifiable using a common text editor program and may be transferred to the TINI™ file system using a FTP utility. The IP port number may not be configurable in the standard text configuration file, but may be configured in the TINI™ Operating System startup file which is a standard text file edited and transferred using a common text editor and FTP utility.

The Dallas Semiconductor TINI™ server 123 provides a Real-Time Clock function. The date and time are set using the TINI™ Operating System configuration command provided. The I/O board periodically reads the Real-Time Clock and converts the reading to the current date and time.

The system communicates using two IP port numbers. One IP port is the standard HTTP port, port 80. The second port is configurable and can be any valid IP port number. The default communication IP port number is port 1025. The second IP port is used for data communications between the control Applet and the I/O board. Periodic data messages are transmitted to each connected user. This periodic communication maintains the connection status for each Applet to the I/O Board and contains the date and time data.

The software component implements a Java™ Applet that provides the user graphical interface for controlling and monitoring the power and reset outputs and the temperature input. After initialization, the Applet opens a TCP/IP socket connection to the I/O board using a configurable IP port number, establishes and maintains the network connection during operation. Once the network connection is established and the Applet initialization completed, a user login box displays, requiring a valid username and password. After successful login, the Applet controls and displays become visible.

The Applet provides a list box from which 1 of 68 power and reset output pairs are selected for operation. In addition to the 1 to 68 power and reset output pairs in the list box, an “All” selection is provided to select all outputs for the selected action. The user then selects the action to be performed: “Power On,” “Power Off” or “Reset.” The default action is “Reset.” Once the selection has been completed the user activates a control button to complete the action. Then the power or reset output for the selected pair(s) is activated.

The Applet displays the current temperature reading with a configurable label in the configured units either Fahrenheit or Celsius. Fahrenheit units will be the default display. In addition to the temperature input display the current set date and time will be displayed. The time will be displayed with a precision to one second and is continuously updated while a network connection is established with the I/O board.

If the network communications fails, the Applet displays an error banner indicating this failure.

Thus, a remote user may monitor and shut down or reset a computer, computer component or computer system without physically travelling to the location of the computer, computer component or computer system.

While particular embodiments of the present invention have been disclosed, it is to be understood that various different modifications and combinations are possible and are contemplated within the true spirit and scope of the invention. There is no intention, therefore, of limitations of the appended claims to the exact disclosure pr abstract herein presented.

What is claimed is:

1. A method of controlling a group of computer units mounted on a rack, comprising:
receiving a computer unit performance signals at a reset control module mounted on the rack;
generating a control signal in response to the receipt of the performance signal for a given control unit; and
sending the control signal to the given one of the computer units for causing it to be controlled in response thereto.

2. A method according to claim 1, wherein said control signal is a reset signal for resetting the given one of the computer units.

3. A method according to claim 2, wherein said control signal is indicative of either controlling the power to the given one of the computer units or requesting it to trigger a reset mode of operation.

4. A method according to claim 1, wherein said receiving computer unit performance signals are received from a sensing device mounted on the rack for detecting malfunctions.

5. A method according to claim 4, further including determining whether the condition is within pre-determined limits.

6. A method according to claim 5, wherein said control signal is a reset signal generated when the condition is determined to be outside of the predetermined limits.

7. A method according to claim 4, wherein said sensing device is a temperature sensing device.

8. A method according to claim 5, further including sending an alarm message to a remote computer to indicate that a malfunction has occurred when it is determined that the condition is outside said limits.

9. A method according to claim 8, wherein said message is sent after a predetermined time delay following the determination that the condition is outside said limits.

10. A method according to claim 9, further including repeating the sending of the alarm message after another time delay interval.
